(19) United States
(12) Patent Application Publication
(10) Pub. No.: US 2022/0095016 A1
(43) Pub. Date: Mar. 24, 2022

(54) Digital entertainment applications where users pay for virtual events hosted by celebrities on mobile and other digital devices

(71) Applicants: Tracy McKinney, cranston, RI (US); Jacqueline McKiiney, warwick, RI (US)

(72) Inventors: Tracy McKinney, cranston, RI (US); Jacqueline McKiiney, warwick, RI (US)

(21) Appl. No.: 17/026,201

(22) Filed: Sep. 19, 2020

(51) Int. Cl. H04N 21/4788; G06Q 30/00; G06Q 50/00; H04N 5/91; H04N 21/2187; H04N 21/433; H04N 21/6587; H04N 21/6543; H04N 21/472

(52) U.S. Cl. CPC H04N 21/4788; G06Q 30/01; G06Q 50/01; H04N 5/91; H04N 21/47217; H04N 21/4334; H04N 21/6587; H04N 21/6543; H04N 21/2187

(57) ABSTRACT

Aspects of the subject disclosure may include, for example, a method comprising of an application presenting entertainment events to users for purchase with a direct connection to a celebrity and the opportunity to receive answers to questions the users submit. The method may include notifications, tracking and capturing electronic data in a recorded video. The method may include confirming the identity of a user and linking the user to specific content for display in a virtual room.

### FIELD OF THE DISCLOSURE

Subject disclosure relates to a system and method for enhanced features in on demand live media streaming

### BACKGROUND OF THE INVENTION

People generally like to connect with celebrities. For example, people use social media sites to stay connected and aware of what celebrities are doing, eating, drinking and wearing. Embodiments of the present invention relate generally to a method, system and computer program for enhanced content and functionality for a virtual video conference

### BRIEF SUMMARY OF THE INVENTION

The application takes virtual meeting room functionality and merges it with live and pre-recorded entertainment to allow fans a more personal connection with their favorite celebrities. Users submit specific questions to celebrities and the answers are provided in live events or recorded videos. The application offers a range of events which meet the needs of all age groups.

### BRIEF DESCRIPTION OF THE SEVERAL VIEWS OF THE DRAWING

FIG. 1 The Home page of the application which displays clickable pictures of pre-recorded and live events. Clicking a pre-recorded event brings the user to FIG. 2. Clicking on a live event brings the user to FIG. 6

FIG. 2 Page allows user to select a celebrity via a drop down box, enter payment information, add email address to invite additional users, select an event date, event time, or play now, select a virtual city and identify an attire all users should wear. Submit button brings user to FIG. 3

FIG. 3 Page displays a list of questions which can be selected by clicking a checkbox. Submit button brings the user to FIG. 4

FIG. 4 Confirmation page for the purchase of a pre-recorded event. Includes name of event, event date and time, email address for invited friends, virtual city and selected attire

FIG. 5 Virtual meeting room displayed on a laptop, phone, Smart TV or iPad device. Displays the screens for two or more live camera feeds on the top right of the screen. Main display in the middle of the screen plays a pre-recorded video

FIG. 6 Details of the live event. Display includes picture of the celebrity, short description of the event, event date, event time, event duration, maximum number of attendees and current number of tickets sold. Clicking purchase button brings the user to FIG. 7

FIG. 7 Live event payment information and input boxes to submit questions to the celebrity during the live event. Submit button brings the user to FIG. 8

FIG. 8 Live streamed virtual event. Box at top left is the live camera feed of a fan. Long box at top right is a question the celebrity needs to answer. Box in middle of screen is the live camera feed of the celebrity. Up to ten fans displayed and rotated on the main event screen.

FIG. 9 Exploded view of the box at top right of FIG. 8. Displays text of the question submitted from FIG. 7

FIG. 10 Exploded view of camera feed of a fan from FIG. 8.

FIG. 11 Host log in page. Displays event name, event date, event start time, duration of the event and number of fans in attendance. The host starts the event by clicking the begin button. The user is brought to FIG. 12

FIG. 12 Host view page of the Live streamed virtual event. Screen is similar to FIG. 8 with one additional feature. A streaming prompt is available only to the Host

FIG. 13 Exploded view of prompt queue for the Host from FIG. 12. These boxes display questions submitted by fans. Host can click ‘select’ or ‘delete’. If Host clicks ‘delete’ the question is removed from the screen. If Host clicks ‘select’, the question appears in FIG. 9 and then is removed from the hosts prompt queue. Questions with no action are saved to the database.

FIG. 14 Exploded view of live camera feeds from FIG. 8. User can select the or ‘>’ icons to scroll through all attendees in the virtual room

FIG. 15 Gallery View of live camera feeds from a Live Event

FIG. 16 Displays all purchases and rentals made by the user

FIG. 17 Personal View and recording page for the celebrity. Celebrity can add their picture, name and short biography. Celebrity can record a video for a specified event. The celebrity video is used for a pre-recorded event. The page also notifies the celebrity of action items they need to take care of.

FIG. 18 Exploded view of the area for the celebrity's picture and name from the upper left corner of FIG. 17

FIG. 19 Exploded view of the input box for celebrity to enter their biography from upper right corner of FIG. 17

FIG. 20 Exploded view of the notification box of what items the celebrity needs to respond to. This includes questions, introductions or new events that the celebrity needs to record from middle of screen FIG. 17.

FIG. 21 Exploded view of the questions or instructions is displayed to the celebrity from middle of screen FIG. 17

FIG. 22 Exploded view of the large recording screen for the celebrity from FIG. 17

FIG. 23 Celebrity Hosted Events page. Displays all events which a celebrity hosts and can be purchased by fans

FIG. 24 Administrator's page in the application

FIG. 25 Exploded view of the Gallery Rotation from FIG. 24

FIG. 26 Process flow for a recorded video from FIG. 17

FIG. 27 Process flow for a recorded video of an introduction from FIG. 17

FIG. 28 Process flow for a purchased recorded video to play at a future date

FIG. 29 Process flow for a purchased recorded video to play immediately

FIG. 30 Process flow for questions submitted during a live event from FIG. 7

FIG. 31 Process flow for rotation of Fan Gallery from FIG. 14

FIG. 32 Process flow for notifications to Celebrity from FIG. 17

### DETAILED DESCRIPTION OF THE INVENTION

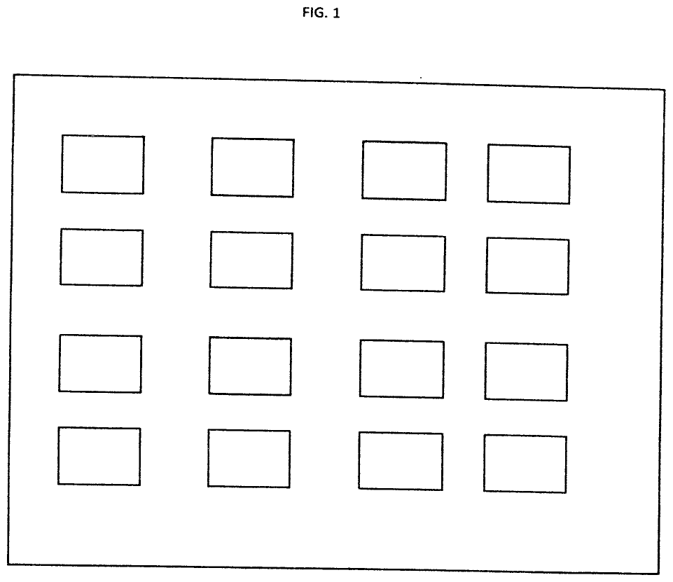

FIG. 1 Display of the home page of the virtual application that is accessible on a phone, laptop, computer, Smart TV or any other electronic device with internet access. The boxes represent events which can be purchased by the user. When the user clicks on an event, the application takes the user to the landing/main page for the event. There are two types of events available for purchase; pre-recorded videos viewable in a virtual room and live events viewed in a virtual room. This is existing digital functionality.

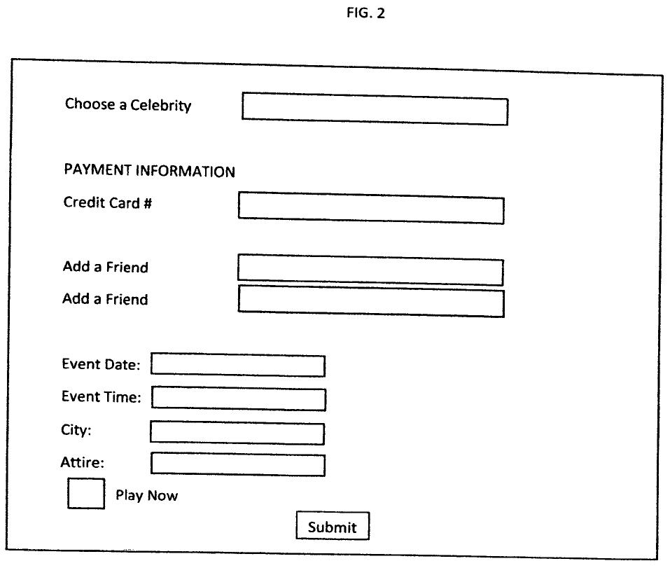

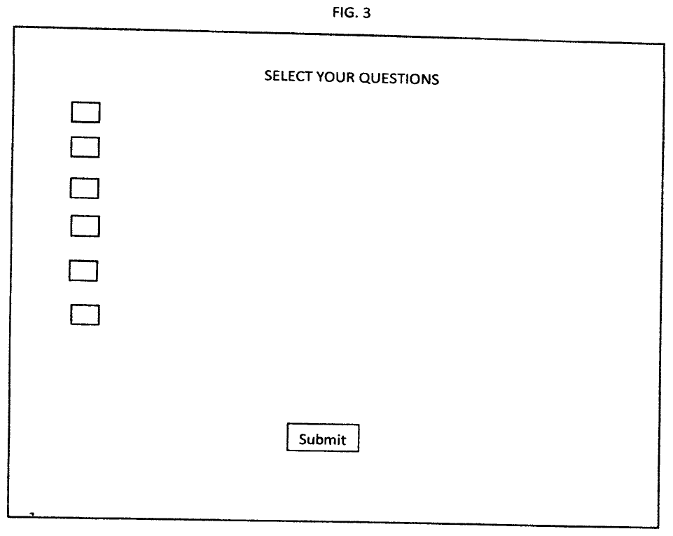

FIG. 2 Landing/main page for a pre-recorded event. The page displays a drop down box where the user can select a celebrity's name, input field for credit card information, two input fields for an email address, enter a date/time when the virtual room and pre-recorded video event should occur, or play the video immediately, select a virtual city from the drop down where the attendees' background in a virtual room shows a static picture of that city and select the attire from the drop down all guests should wear. The user fills out the fields and clicks the submit button. The application brings the user to FIG. 3. This is existing digital functionality

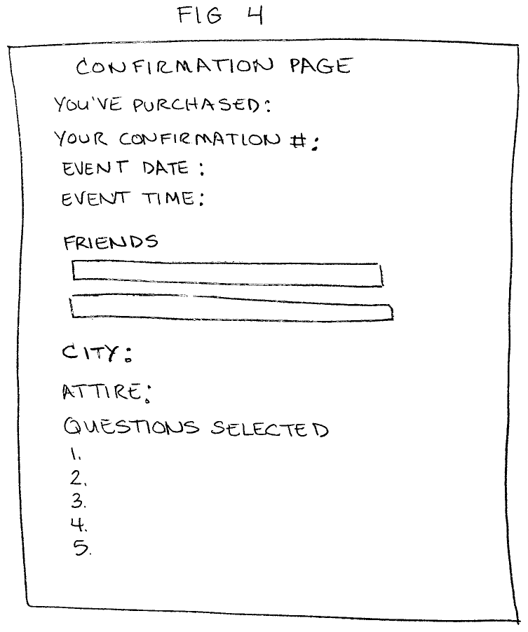

FIG. 3 This page allows the user to select questions they would like to have a celebrity answer in the celebrity's recorded video. The user clicks on the checkboxes on the page to select the questions. The user clicks the submit button and the application brings the user to FIG. 4. This is existing digital functionality

FIG. 4 The confirmation page provides the details which were selected during the purchase of a pre-recorded event. Details include textual confirmation of what event was purchased, a unique system generated confirmation number, the date the event plays, the time the event plays, email addresses the user provided, the virtual background selected, the attire the user selected and the list of questions selected. The Web Server generates a confirmation number that is displayed on the screen. An email is sent to the invited guests notifying them of the event date and time. This is existing digital functionality. IMPROVEMENT: A unique event number is generated and linked to the purchaser's customer number and linked to the unique identifier of the questions. The web server passes the event number, customer number and question's unique identifier numbers and text of the questions to the database and stores all data in the event table.

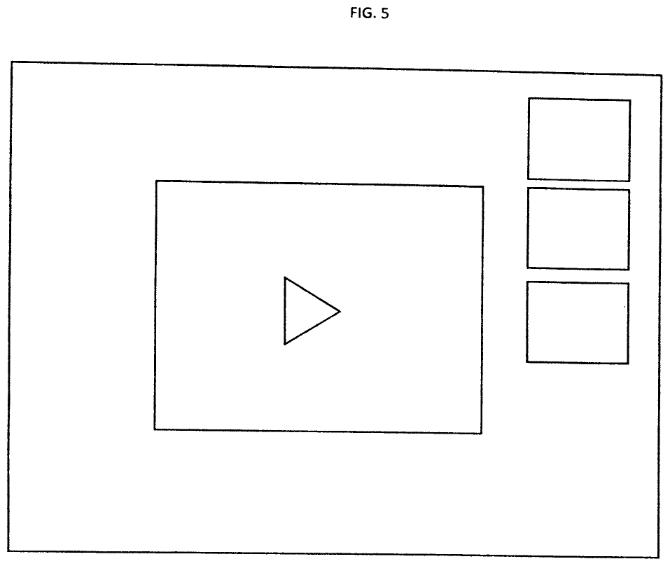

FIG. 5 Virtual meeting room the purchaser and invited email guests join on the day/time of the purchased event. The celebrity's pre-recorded video is displayed prominently in the middle of the screen. The video is displayed on the event date and time the purchaser selected when the purchaser enters the virtual room. The purchaser controls when to start and stop the video. The live camera feed for the purchaser and the camera feeds of the invited email guests are displayed along the right side of the screen. This is existing digital functionality.

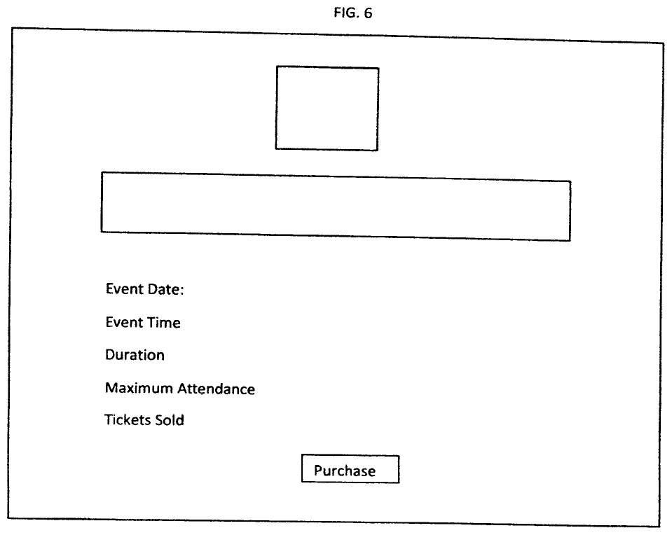

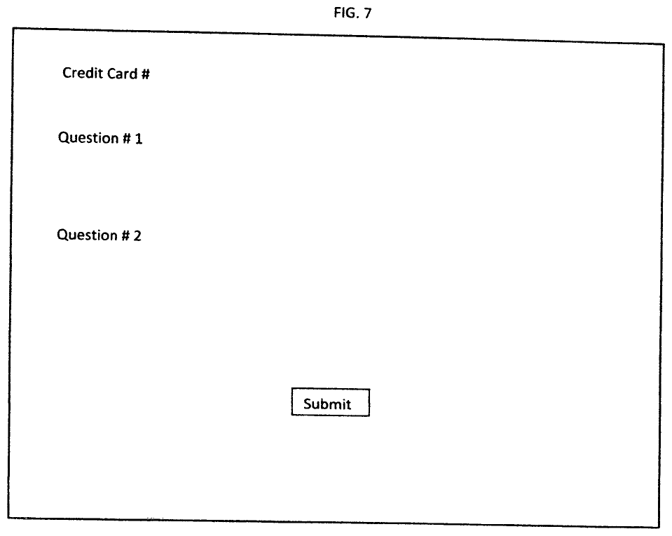

FIG. 6 Live Event Landing page. A picture of the celebrity is the box at the top of the screen, a short biography of the celebrity is under the celebrity's picture, the event date, event time, duration of the event, maximum number of fans allowed to attend the event and the number of tickets currently sold are displayed. The submit button brings the user to FIG. 7. Each live event has a unique identifier and has its own table in the database. This is existing digital functionality

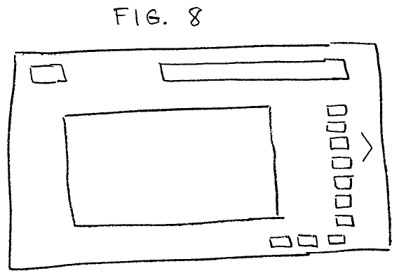

FIG. 7 Payment page for Live Event. The page displays input fields for credit card/payment information and two input fields which are optional to enter questions for the celebrity. Clicking ‘submit’ brings the user to FIG. 8. This is existing digital functionality. IMPROVEMENT: A unique identifier is created for the questions in the input fields and linked to the purchaser's customer number and the unique event ID. The prefix for each question's unique identifier starts with the customer number+event ID and ends with 001 and 002, respectively. The event ID, purchaser's customer number, question's unique identifier numbers and text of the questions are passed to the web server and stored in the events table in the database.

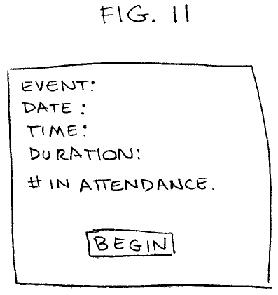

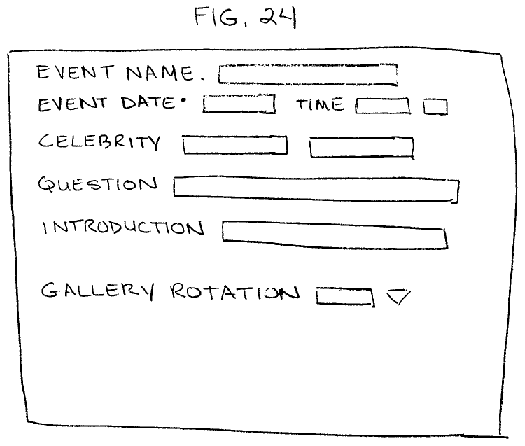

FIG. 8 Virtual room of the Live Event. The Main display is the live camera feed of the celebrity. The small boxes on the side and bottom right of the screen are camera feeds of fans attending the live event. The small box at the top left is a live camera feed of the fan whose question is being displayed in the rectangular box at the top right. The celebrity answers the question displayed in the rectangular box at the top right. IMPROVEMENT: The ten camera feeds on the side and bottom right of the screen are randomly rotated to display a new group of attendees in the virtual room. The rotation timing of the ten camera feeds is controlled by the administration functions of the application FIG. 24 and stored in the event table in the database. When the host starts the event FIG. 11, the web server sends notification to the application to rotate the camera feeds every X number of minutes. Camera feeds on the main event screen are rotated to the last page of the gallery of camera feeds and ten camera feeds from the second gallery page are moved to the main event screen.

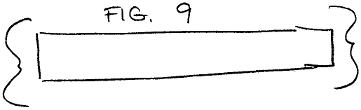

FIG. 9 An exploded view of the current question that the celebrity is being asked in the live virtual room by the host from FIG. 8 at the top right.

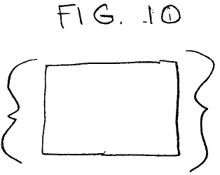

FIG. 10 An exploded view of the live feed of the fan in the top left corner from FIG. 8. This fan is linked to the question submitted in FIG. 7

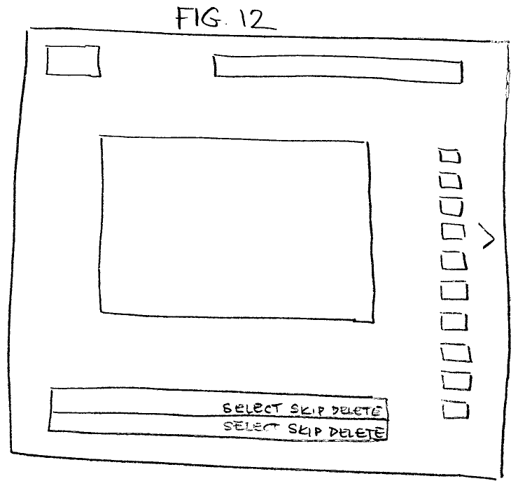

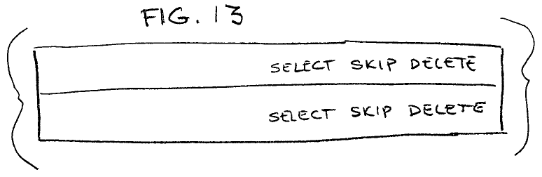

FIG. 11 The Host's log-in page. The page displays the Event name, Event Date, Event start time, duration of the event and the number of fans who have purchased the event. The host starts the event by clicking the begin button. FIG. 12 is displayed. This is existing digital functionality. IMPROVEMENT: When the host clicks ‘begin’, the application sends a notification to the client side application that the event has begun. The client side application sends a request to the web server to pull all questions associated with the unique event ID. The web server searches the database tables for the event ID and pulls the customer numbers, question unique identifiers and text of all of the questions. The web server returns the data to the client side. When the host joins the virtual room FIG. 12 the client side loads text of two questions, along with the customer number and question unique identifier in the host's queue in FIG. 13. The client side application stores up to 2000 questions for each live event.

FIG. 12 The Host's View for a Virtual Live Event. The Main box is the live camera feed of the celebrity. The small boxes on the side and bottom right of the screen are camera feeds of fans attending the live event. The small box at the top left is a live camera feed of the fan whose question is being displayed and answered. The rectangular box at the top right is the question which is being asked. IMPROVEMENT: The host can skip, delete or select a question by clicking a button. When the host clicks the delete button, the question is removed from the prompt display FIG. 12 and exploded view FIG. 13. When the host clicks the skip button, the question is stored in the client server and moved to the bottom of the list of questions. When the host clicks the select button the following occurs:
A. Application locates the customer number linked to the question
B. The customer number is linked to the screen in the top left corner. The fan's camera feed is displayed in the top left corner
C. Simultaneously, the question associated with the customer number appears in the rectangular box at the top right of the screen
D. Simultaneously, the question is removed from the hosts queue prompt FIG. 13 and the client side application pushes a new question to the bottom of the hosts prompt
E. This process is repeated until the live event is ended by the host or until the client side application has no more questions stored
F. Once the host ends the live event, the client side application sends the event ID, customer number, unique identifier for questions and the text of the questions to the web server
G. The Web Server sends all data to the database and store in the events table.
H. All questions that were ‘selected’ have a status of ‘answered’ in the event table. Questions that were ‘skipped’ have a status of ‘skipped’ in the event table. Questions that were ‘deleted’ have a status of ‘inappropriate’ in the event table. Questions that had no action taken by the host have no status in the event table

FIG. 13 An exploded view of the hosts prompt from FIG. 12

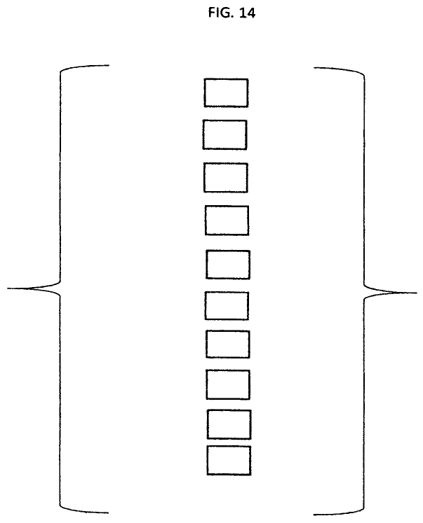

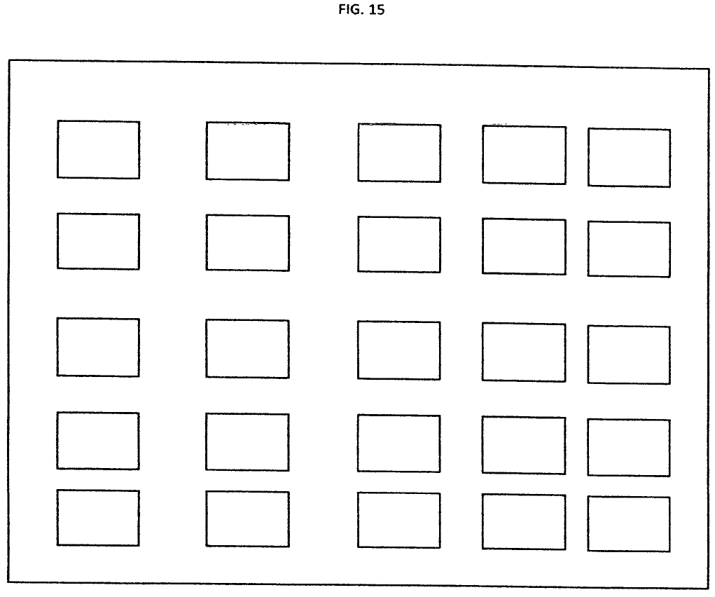

FIG. 14 Exploded view of live camera feeds from FIG. 12 right side of screen. Any user can select the ‘<’tor ‘>’ icons to scroll through all attendees in the virtual room. A maximum of ten camera feeds are displayed in the main event page where the celebrity is being viewed. Selecting the ‘>’ brings a user away from the main screen view of the celebrity to the display of twenty-five camera feeds FIG. 15. This is existing digital functionality

FIG. 15 Live events can host up to one thousand camera feeds. The main event page where the celebrity is viewed only displays ten camera feeds from the gallery. Clicking the ‘>’ icon from FIG. 8 brings the user to FIG. 15 which displays up to twenty-five camera feeds per page. Selecting ‘>’ again brings the user to another screen of twenty-five camera feeds. Continuing these steps brings the user to the last display of camera feeds. To return to the main screen a user clicks the ‘<’ icon until the main screen is displayed. This is existing digital functionality.

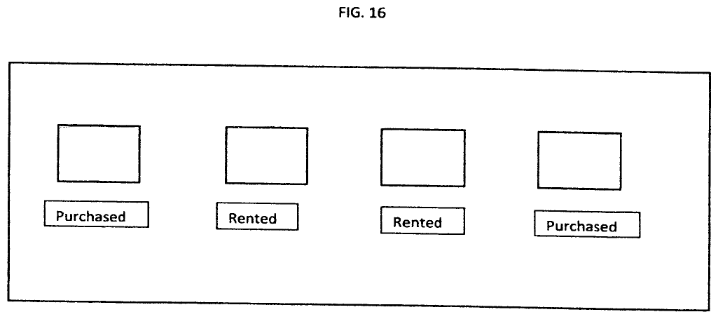

FIG. 16 A view of all events a purchaser has made. The page provides a static picture of the event, the date the event was purchased or rented, whether the event was rented or purchased, if rented how much time there is left to view the event. This is existing digital functionality

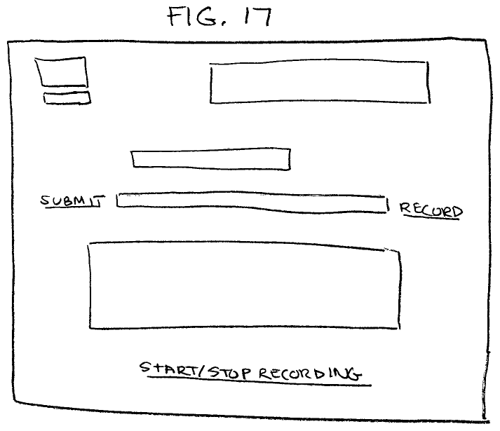

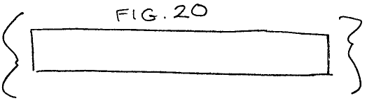

FIG. 17 The Celebrity's Biography and Recording page. The celebrity can add/edit their picture, name and short biography. The celebrity also records events, questions and introductions. The event name is displayed on the page and has a unique identifier. The celebrity uses the start/stop recording button to record their videos. A push notification is sent to the celebrity's phone or email address by the Web Server. The notification includes a link to the Celebrity's Biography page when updates are needed. IMPROVEMENT: An indicator, exploded view FIG. 20, is displayed on the screen informing the celebrity they have an event, questions or other action items that must be recorded.

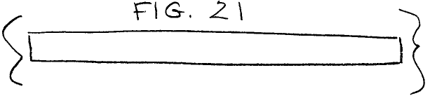

The process for question: If a question must be answered, the application calls the server using the event unique identifier associated with FIG. 20. The web server pulls all questions from the database, passes them to the client side server and the client side server stores the questions and feeds them one by one to the application in FIG. 21. The celebrity clicks the start record button. Once the question is answered they click the stop record button. A message appears on the screen asking the celebrity if they want to submit the video or would they like to re-record. If they click re-record, the previous video is recorded over and they record their answer again and click stop. If they click submit, the video is passed to the client server and stored there until the celebrity has completed recording answers to all of their questions. Once all questions are answered the client side application sends the data to the web server and the data is stored in the database. The exploded view FIG. 20 disappears from the screen.

The process for an introduction: If the celebrity must record an introduction, exploded view FIG. 20 indicates an introduction must be recorded for a specific event. When the celebrity clicks on exploded view FIG. 20, the web server pulls the instructions from the database, passes them to the application and post the text on the screen. The celebrity clicks the start record button. Once they have completed their recording they click the start/stop record button. A message appears on the screen asking the celebrity if they want to submit the video or would they like to re-record. If they click re-record, the previous video is recorded over and they record their introduction again and click stop. If they click submit, the video is passed to the client side app. The client side app sends the video to the web server and stores the introduction recording in the database with its unique identifier.

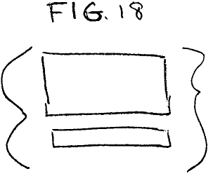

FIG. 18 Exploded view of the area for the celebrity's picture and name from top left of FIG. 17. The celebrity uploads their picture and input their name. This is existing digital functionality

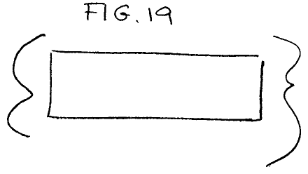

FIG. 19 Exploded view of the input box for celebrity to enter their biography from top right of FIG. 17. The celebrity inputs a description of their biography. This is existing digital functionality

FIG. 20 Exploded view of the notification box from FIG. 17 of what items the celebrity needs to respond to. This includes questions, introductions or new events that the celebrity needs to record. The application administrator determines when a celebrity needs to respond to questions or complete an introduction by updating the celebrity's action plan. The application sends the data associated to the action plan to the web server. The web server stores the data in the database to the celebrity's table. When the celebrity logs into FIG. 17, FIG. 20 notifies the celebrity they have action items. This is existing digital functionality.

FIG. 21 Exploded view of the questions or instructions displayed to the celebrity which they must make a recording for from FIG. 17.

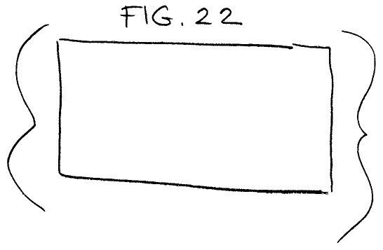

FIG. 22 Exploded view of the recording screen for the celebrity from FIG. 17

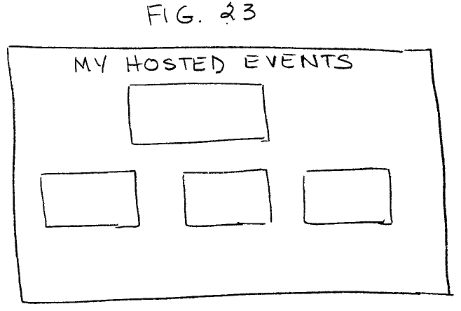

FIG. 23 Page shows all events which a specific celebrity offers for purchase. This is existing digital functionality

FIG. 24 Administrator's screen—administrator controls certain functions of the application.

Administrator enters questions and details on introductions which the celebrity must provide recordings for. After an introduction or question is entered it is stored in the database and identified with a unique-identifier associated with a celebrity.

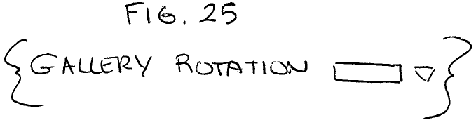

FIG. 25 Exploded view of the field to determine the rotation interval of the gallery from FIG. 24

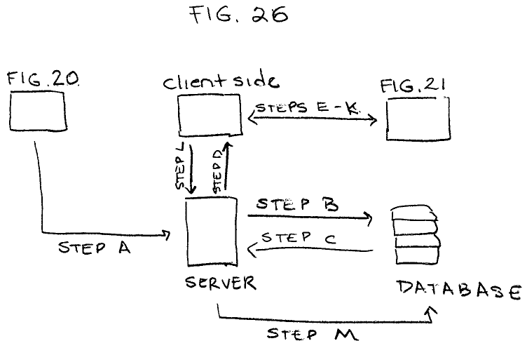

FIG. 26 IMPROVEMENT: Process flow of Celebrity Recordings identified in FIG. 17.
Process flow for Questions: FIG. 17 indicates that the Celebrity must record a video to answer specific questions, the process is initiated when the administrator inputs data from FIG. 24
Step A—the celebrity clicks FIG. 20 and a request is sent to the web server to search for all questions associated to the events unique identifier.
Step B—the web server locates the event unique identifier in the database and pulls all questions in the table
Step C—All records are returned to the web server
Step D—The web server passes all records to the client side application and the client side application stores the records
Step E—The client side passes the questions one by one to the application in FIG. 21
Step F—The celebrity clicks start to record an answer to the question displayed in FIG. 21
Step G—The celebrity clicks the stop record button from FIG. 17
Step H—A message appears on the screen asking the celebrity if they want to submit the video or would they like to re-record.
Step I—Clicking re-record from FIG. 17, the previous video is recorded over and they record their answer again and click stop OR clicking submit, the video is passed to the client server and stored there until the celebrity has completed recording answers to all of their questions
Step J—The client side loads the next question into FIG. 21 and store the answer to the first question
Step K—once the client side server question storage is empty FIG. 21 disappears from the screen on FIG. 17.
Step L—all recordings are passed from the client side to the web server
Step M—the web server passes the data to the database and stores the data in a table associated to the celebrity unique identifier and the event's unique identifier

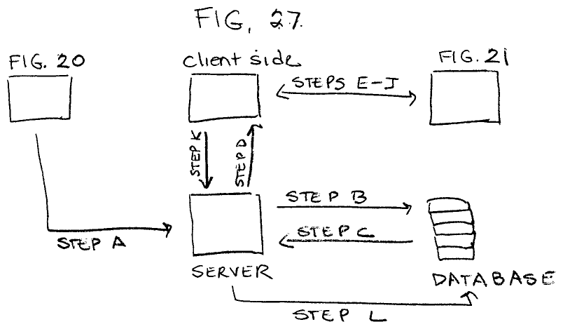

FIG. 27 IMPROVEMENT: Process flow for an Introduction: FIG. 20 indicates that the Celebrity must record an introduction to a specific event from FIG. 17
Step A—the celebrity clicks FIG. 20 and a request is sent to the web server to search for the events unique identifier.
Step B—the web server locates the event unique identifier in the database and pulls the instructions for the introduction
Step C—The instructions are returned to the web server
Step D—The web server passes the instructions to the client side application and the client side application
Step E—The client side passes the instructions to the application in FIG. 21
Step F—The celebrity clicks the start record button when ready
Step G—The celebrity clicks the stop record button when complete
Step H—A message appears on the screen asking the celebrity if they want to submit the video or would they like to re-record.
Step I—Clicking re-record on FIG. 17, the previous video is recorded over and they record their introduction again and click stop
Step J—The celebrity clicks the submit button to send the recording from FIG. 17.
Step K—The recording is passed from the client side to the web server
Step M—the web server passes the data to the database and stores the data in a table associated to the celebrity unique identifier and the event's unique identifier

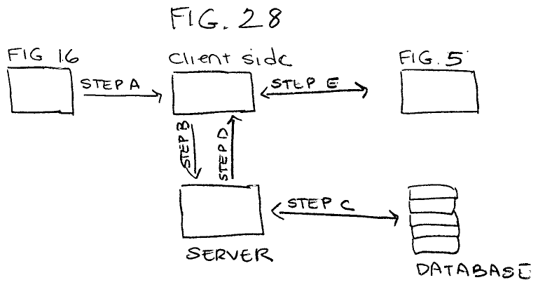

FIG. 28 IMPROVEMENT: Process flow for questions/answers for viewing pre-recorded events in for a future date
Step A—Purchaser clicks on the picture graphic from My Gallery FIG. 16
Step B—client side application sends event unique ID and purchaser's customer number to the webserver
Step C—Webserver sends event unique ID and customer number to the database and pulls data from event table
Step D—Web server formats video and returns video to the client side app
Step E—client side app loads video to FIG. 5 simultaneously as purchaser enters the virtual room

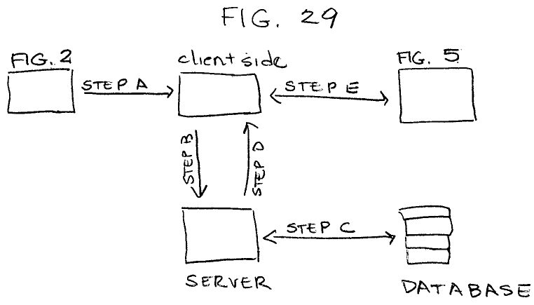

FIG. 29 IMPROVEMENT: Process flow for questions/answers for viewing pre-recorded events immediately after purchase
Step A—User selects play now from FIG. 2 and selects questions from FIG. 3
Step B—client side application sends event unique ID and purchaser customer number to the webserver
Step C—Webserver sends event unique ID and customer number to the database and pulls data from event table
Step D—Web server formats video and returns video to the client side app
Step E—client side app loads video to FIG. 5 simultaneously as purchaser enters the virtual room

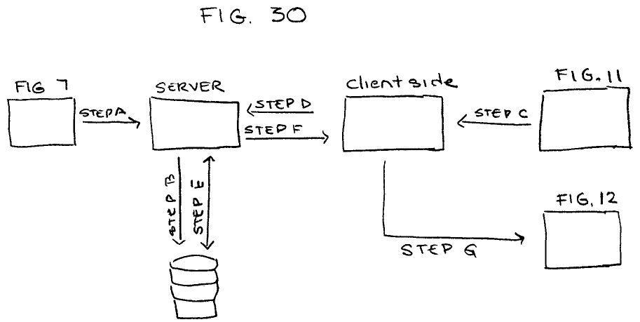

FIG. 30 Process Flow for Questions submitted for the live event IMPROVEMENT:
Step A—the purchaser inputs questions in FIG. 7. The questions are sent to the web server along with the unique identifier of the event, the unique identifier of the purchaser and the unique identifier for each question.
Step B—the web server sends all data to the database where it is stored in a table for the event
Step C—when the host begins the event FIG. 11, the applications sends a notification to the client side application that the event has begun.
Step D—the client side application sends a request to the web server to pull all questions associated with the unique event ID
Step E—the web server accesses the table of the unique event ID and pulls the customer number, the questions unique identifier and the text of all questions
Step F—the web server returns the data to the client side.
Step G—the client side loads the text of two questions, along with the purchaser's customer number and question unique identifier to the host prompt in FIG. 12.
Step H—The client side application locates the customer number and unique identifier of the question and load the camera feed of the fan in the top left corner of the screen

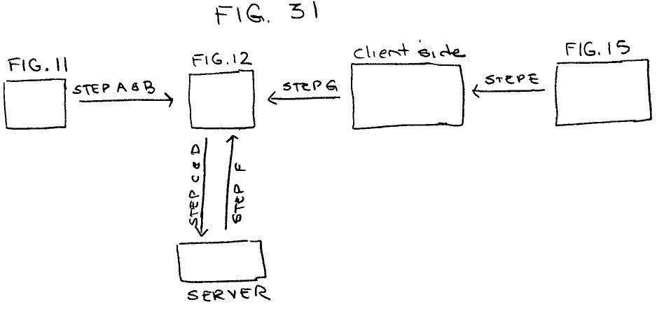

FIG. 31 Process Flow for Rotation of Fan Gallery in a Virtual Room
Step A—Hosts starts event FIG. 11
Step B—Live camera feeds are displayed in FIG. 8 as fans join the event with a maximum of ten camera feeds shown in the gallery view.
Step C—As fans join the virtual room the web server scans customer numbers and link the customer number to the camera feed.
Step D—The web server stores this data temporarily
Step E—Simultaneously with Step A, the application sends a response to the client side application that the camera feeds should be rotated in X number of minutes determined from Administrators page from FIG. 24, ‘gallery rotation’ exploded view FIG. 25
Step F—Web Server sends notification to Application to rotate ten camera feeds of the main event page FIG. 12, move them to the last gallery page FIG. 15 and move ten camera feeds from the second gallery page to the main event page. This process continues until the host ends the event.

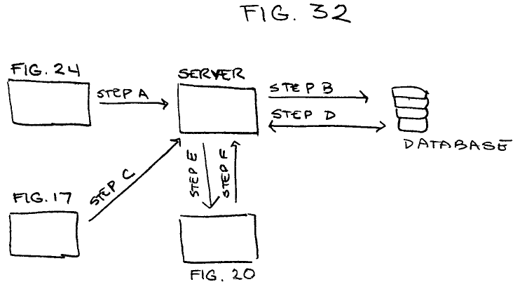

FIG. 32 Process flow for Notifications to Celebrity
Step A—Administrator enters instructions from FIG. 24 for celebrity and application sends data to the Web Server
Step B—Web Server sends the data to the database to store in the celebrity's table
Step C—Celebrity logs into FIG. 17. Upon login, application sends notification to Web Server FIG. 24.
Step D—Web Server pulls data from database
Step E—Web Server returns action items that the celebrity must complete to the application into FIG. 20.
Step F—Celebrity completes the steps provided in FIG. 20. Once recordings are complete all data is sent to the Web Server

What is claimed is:

1. A system, where on the day and time for a pre-scheduled virtual event, the customer logs in and the client server tags the camera feed with the associated customer ID;
the facilitator starts the virtual event by clicking a button on the User Interface; the client server sends a request to the web server to pull all records associated with the event ID; the web server scans the database and pulls the customer ID, list of previously submitted questions and unique identifiers for the submitted questions; the web server returns the data to the client server; the client server feeds the questions to the host prompt queue on the user interface and tags the questions fields with the associated customer ID and the question ID; the facilitator selects a question from the prompt queue and the client server searches for the camera feed associated with the customer number and moves the camera feed to the main virtual room.

2. The system of claim 1, where the client server sends a request to the web server to create a unique identifier for the questions entered in the customer input boxes; web server passes the unique identifier for the questions back to the client server; client server bundles the questions unique identifier, questions from the customer input boxes, event ID and customer ID and returns to the web server; the web server sends the customer ID, unique identifier of the event, the unique identifier for the questions, the questions and the customer ID for storage in the database.

3. The system of claim 1, where on the date and time of the event, the client server sends a notification to the web server that the event has begun and the web server pulls the customer ID, unique identifier of the questions, the questions from the customer input boxes and the event ID from the database.

4. The system of claim 1, where the web server returns the customer number, unique identifier from the questions, the questions from the customer input boxes and event ID to the client side application where the client side application caches the customer ID, unique identifier of the questions, event ID and questions from the customer input boxes until a request is received from the user interface to populate the data on the user interface screen.

5. The system of claim 1, where the user interface begin button notifies the client side application to request the previously submitted customer questions; the client server requests the customer questions, unique identifier for the questions and the customer ID from the web server; the web servers scans the database for the data associated with the event ID; the web server returns the data to the client server; the client server loads the questions to the hosts prompt queue and tags the fields with the unique identifier of the questions and the customer ID.

6. The system of claim 1, when the host clicks ‘select’ on the question in the host prompt queue in the live virtual room, the client server scans the camera feeds for the associated customer ID; the client server moves the camera feed to the main virtual room and the selected question is displayed in the fixed area for the text display.

7. Application controlled rotation of camera feeds in a virtual room.

8. The system of claim 7, where the administrative functions of the application sets a predetermined time for the rotation of camera feeds in a virtual room.

9. The system of claim 7, where the application sends notification to the web server that the event has begun and users are in the virtual room.

10. The system of claim 7, where the web server reads the gallery rotation field on the administrator screen and sends notification to the client server to rotate camera feeds associated with the unique Event ID.

11. The system of claim 7, where camera feeds from one page are moved to a different page.

12. The system of claim 7, where the web server repeats the process of rotation based on the notification from the application.

13. Controlled Display of data through use of an active prompt in a virtual room and display data in multiple locations in the virtual room.

14. The system of claim 13, where the client side application sends notification to the web server to pull all data associated with the unique event ID, customer number, unique identifier for text and text.

15. The system of claim 13, where the web server retrieves all data and sends to the client side application, where the client side application stores data until needed by the application.

16. The system of claim 13, where the client side application passes the data to the administrator's virtual screen in a prompt display where the administrator can direct an action on the screen for the data to be displayed in specific areas and/or data fields.

17. The system of claim 13, where clicking an action button removes data from a prompt queue, clicking an action button relocates data from a prompt queue to a different field on the virtual screen and clicking an action button notifies the client side application to remove the data from a prompt queue and store the data in the client side application for future use.

18. Recorded videos prompted by auto-generated instructions via push notifications and merged into one video.

19. The system of claim 18, where the client receives a unique identifier notification via text or email that they must record a video.

20. The system of claim 18, where the client logs into the application and the client side application notifies the web server to pull instructions specific to the clients unique ID.

21. The system of claim 18, where the web server pulls instructions for the customer ID and passes the instructions to the application.

22. The system of claim 18, where the application displays a custom prompt with the instructions.

23. The system of claim 18, where the client uses the start record button as a method to record a video based on the auto-generated instructions.

24. The system of claim 18, where the client uses the stop record button to notify the client side application that the action item is pending review.

25. The system of claim 18, where the client side application displays ‘submit’ and ‘rerecord’ buttons on the screen for the client to determine the next action.

26. The system of claim 18, where the client clicks ‘submit’ to notify the client side application that the recording associated with the instruction notice is complete.

27. The system of claim 18, where the client clicks ‘rerecord’ to notify the client side application that the instruction notice is not complete.

28. The system of claim 18, where the auto-generated instructions are removed from the prompt once ‘submit’ is clicked.

29. The system of claim 18, where the client side application sends the recording along with the unique identifier notification to the webserver.

30. The system of claim 18, where the web server pulls all videos specific to a client ID and unique event ID and merges the videos together into one video.

31. The system of claim 18, where the web server passes the video to the application and is available to the user for viewing in a virtual room.
